(19) United States
(12) Patent Application Publication
(10) Pub. No.: US 2013/0302777 A1
(43) Pub. Date: Nov. 14, 2013

(54) SYSTEMS AND METHODS OF OBJECT RECOGNITION WITHIN A SIMULATION

(71) Applicant: Kidtellect Inc., Cambridge, MA (US)

(72) Inventors: Michael Tomkins, Cambridge, MA (US); Stephen Miller, Cambridge, MA (US); Janee Wilson-Key, Boston, MA (US); Gopesh Mittal, Boston, MA (US); Phylaktis Georgiou, Cambridge, MA (US); Jillian Dorrans, Boston, MA (US)

(21) Appl. No.: 13/893,708

(22) Filed: May 14, 2013

Related U.S. Application Data
(60) Provisional application No. 61/646,728, filed on May 14, 2012.
(60) Provisional application No. 61/714,435, filed on Oct. 16, 2012.

(51) Int. Cl. G09B 7/00

(52) U.S. Cl. CPC G09B 7/00
USPC 434/362

(57) ABSTRACT

According to another embodiment, a system configured to execute at least one simulation is provided. The system includes a memory, a touch screen, at least one processor coupled to the memory and the touch screen, and a simulation component executed by the at least one processor. The simulation component is configured to detect a manipulation of at least one object disposed on the touch screen, determine a degree of compliance of the manipulation to rules of the at least one simulation, and communicate a characterization of the degree of compliance to an external entity.

### RELATED APPLICATIONS

This application claims priority under 35 U.S.C. §119(e) to U.S. Provisional Application Ser. No. 61/646,728, titled “SYSTEMS AND METHODS OF OBJECT RECOGNITION WITHIN A SIMULATION,” filed on May 14, 2012, which is hereby incorporated herein by reference in its entirety. This application also claims priority under 35 U.S.C. §119(e) to U.S. Provisional Application Ser. No. 61/714,435, titled “SYSTEMS AND METHODS OF OBJECT RECOGNITION WITHIN A SIMULATION,” filed on to Oct. 16, 2012, which is hereby incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

The technical field relates generally to simulations executed by computer systems and, more particularly, to simulations that educate users by interacting with the user.

2. Discussion

Computer based simulations can be effective instructional tools. Within a computer based simulation, a user performs virtual activities that mimic actual activities within a framework provided by a computer system. Thus, computer based simulations can direct users to perform virtual activities in a manner that promotes education of the user in an environment free of many of the consequences associated with performance of the mimicked actual activity. For instance, a flight simulator can be used to train airline pilots to address particular in-flight issues without endangering the pilot or others.

### SUMMARY

Some of the aspects and embodiments disclosed herein include a simulation component that interacts with a user, and objects manipulated by the user, to provide an educational experience to the user. In some embodiments, the simulation component identifies attributes of the objects manipulated by the user to conduct the simulation. Examples of the attributes identified by the simulation component include physical attributes such as the shape, weight, orientation, and constituent materials of the objects. Other examples of these attributes include logical attributes, such as an object type into which objects are classified. In some embodiments, the simulation component responds to the user based on the identities and physical attributes of the objects. These responses may include a variety of sensory output, such as audio output, visual output, and tactile output. In at least one embodiment, the responses acknowledge the manipulation performed by the user and further communicate characterizations of the manipulation or other actions performed by the user. These characterizations may include whether the manipulation and other actions are correct or incorrect. The responses may also include suggestions for improved user performance.

According to one embodiment, a method for identifying an object is provided. The method includes acts of detecting, by a simulation device, at least two points of contact between the object and a surface of the simulation device and comparing a pattern defined by the at least two points of contact to a predefined pattern associated with the object to identify the object. The pattern defined by the at least two points of contact may be any of a variety of patterns, including those further below.

According to another embodiment, a system configured to execute at least one simulation is provided. The system includes a memory, a touch screen, at least one processor coupled to the memory and the touch screen, and a simulation component executed by the at least one processor. The simulation component is configured to detect a manipulation of at least one object disposed on the touch screen, determine a degree of compliance of the manipulation to rules of the at least one simulation, and communicate a characterization of the degree of compliance to an external entity.

In the system, the simulation component may be configured to communicate the characterization by displaying a representation of the at least one object on the touch screen. The simulation component may be configured to communicate the characterization by communicating suggestions to enable an increase in the degree of compliance. The simulation component may be further configured to determine that the degree of compliance transgresses a threshold and adjust difficulty of the at least one simulation in response to the degree of compliance transgressing the threshold. In the system, the simulation component may be configured to determine the degree of compliance at least in part by identifying the at least one object.

In the system, the simulation component may be configured to identify the at least one object at least in part by comparing a plurality of locations on the touch screen to a plurality of predefined patterns, the plurality of locations on the touch screen being in contact with a plurality of contact points of the at least one object. The plurality of contact points may include at least one of a first set of contact points, a second set of contact points, a third set of contact points, and a fourth set of contact points, the first set of contact points forming an equilateral triangle having sides substantially 31.07 millimeters in length, the second set of contact points forming a triangle including a first side substantially 43.35 millimeters in length, a second side substantially 43.36 millimeters in length, and a third side substantially 43.58 millimeters in length, the third set of contact points forming a line substantially 44.90 millimeters in length, and the fourth set of contact points forming a triangle including a first side substantially 48.48 millimeters in length, a second side substantially 36.15 millimeters in length, and a third side substantially 51.02 millimeters in length. Each predefined pattern of the plurality of predefined patterns may be associated with at least one of a triangle, a star, a square, and a circle.

The system may further comprising a plurality of objects including the at least one object. Each of the plurality of objects may comprise a material that the system can detect while the object is not in contact with a user. The material may include at least one of conductive silicon and stainless steel. Each object of the plurality of objects may be configured to allow light to pass through at least one of a portion of the object and an aperture formed by the object. Each of the plurality of objects may include a beveled bottom.

According to another embodiment, an object for use with at least one simulation system is provided. The object includes a plurality of contact points fabricated from a material that the simulation system can detect while the object is not in contact with a user. The material may include at least one of conductive silicon and stainless steel. The object may be configured to allow light to pass through at least one of a portion of the object and an aperture formed by the object. The object may include a beveled bottom.

According to another embodiment, a method of conducting a simulation using a computer system is provided. The computer system includes a memory, a touch screen, and at least one processor coupled a memory and the touch screen. The method includes acts of detecting a manipulation of at least one object disposed on the touch screen, determining a degree of compliance of the manipulation to rules of the at least one simulation, and communicating a characterization of the degree of compliance to an external entity.

The method may further include determining that the degree of compliance transgresses a threshold and adjusting difficulty of the at least one simulation in response to the degree of compliance transgressing the threshold. The act of determining the degree of compliance may include an act of identifying the at least one object. The act of identifying the at least one object may include an act of comparing a plurality of locations on the touch screen to a plurality of predefined patterns, the plurality of locations on the touch screen being in contact with a plurality of contact points of the at least one object. The act of comparing the plurality of locations on the touch screen to the plurality of predefined patterns may include an act of comparing the plurality of locations with a plurality of predefined patterns including at least one predefined pattern associated with at least one of a triangle, a star, a square, and a circle.

Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a context diagram of a simulation system;

FIG. 2 is a schematic diagram of distributed computer system including a simulation device;

FIG. 3A is an illustration of interface elements provided by the simulation device;

FIG. 3B is an illustration of additional interface elements provided by the simulation device;

FIG. 3C is an illustration of additional interface elements provided by the simulation device;

FIG. 3D is an illustration of additional interface elements provided by the simulation device;

FIG. 3E is an illustration of additional interface elements provided by the simulation device;

FIG. 3F is an illustration of additional interface elements provided by the simulation device;

FIG. 4 is a top view of an example triangular object;

FIG. 5 is a side view of an example triangular object;

FIG. 6 is a bottom view of an example triangular object;

FIG. 7 is a top view of an example star-shaped object;

FIG. 8 is a side view of an example star-shaped object;

FIG. 9 is a bottom view of an example star-shaped object;

FIG. 10 is a top view of an example square-shaped object;

FIG. 11 is a side view of an example square-shaped object;

FIG. 12 is a bottom view of an example square-shaped object;

FIG. 13 is a top view of an example circular object;

FIG. 14 is a side view of an example circular object;

FIG. 15 is a bottom view of an example circular object;

FIG. 16 is a top view of another example star-shaped object;

FIG. 17 is a side view of another example star-shaped object;

FIG. 18 is a bottom view of another example star-shaped object;

FIG. 19 is a top view of another example square-shaped object;

FIG. 20 is a side view of another example square-shaped object;

FIG. 21 is a bottom view of another example square-shaped object;

FIG. 22 is a top view of another example circular object;

FIG. 23 is a side view of another example circular object;

FIG. 24 is a bottom view of another example circular object;

FIG. 25 is a flow diagram illustrating an example simulation process;

FIG. 26 is a flow diagram illustrating an example matching simulation process;

FIG. 27 is a flow diagram illustrating an example stamping simulation process;

FIG. 28 is a flow diagram illustrating an example construction simulation process;

FIG. 29 is a top view of examples of rod objects; and

FIG. 30 is an illustration of additional interface elements provided by the simulation device.

### DETAILED DESCRIPTION

Various embodiments disclosed herein provide for a simulation device and accessories that bridge the physical and digital worlds. For instance, one embodiment includes a collection of specially engineered physical shapes that have capacitive sensors that enable the shapes to be uniquely identified by a simulation device including a capacitive touch screen. One example of such a device is the APPLE IPAD available from Apple Inc. of Cupertino, Calif. In this embodiment, the simulation device includes a simulation component configured to execute a simulation of a physical shape puzzle that is significantly more engaging than conventional puzzles and that is capable of adapting its difficulty level for different age groups and development stages. In addition, in some embodiments, the simulation component allows users to create simulations that include custom photos and vocal prompts. In at least one embodiment, the simulation is customized by adults and conducted by children.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Simulation System

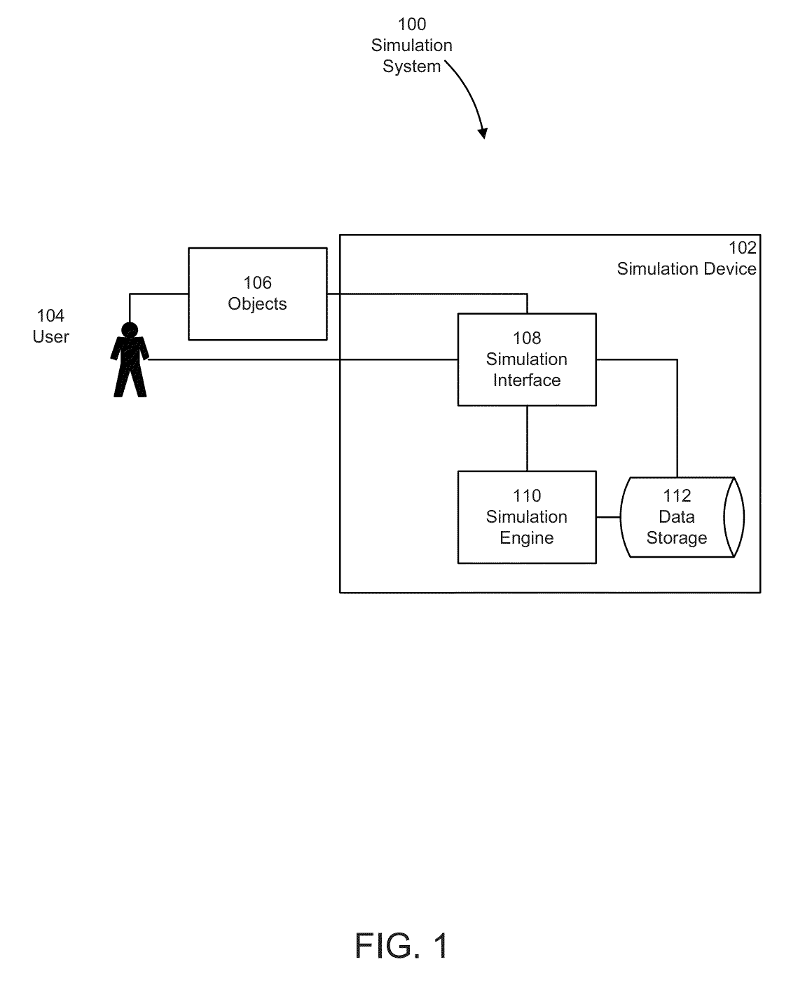

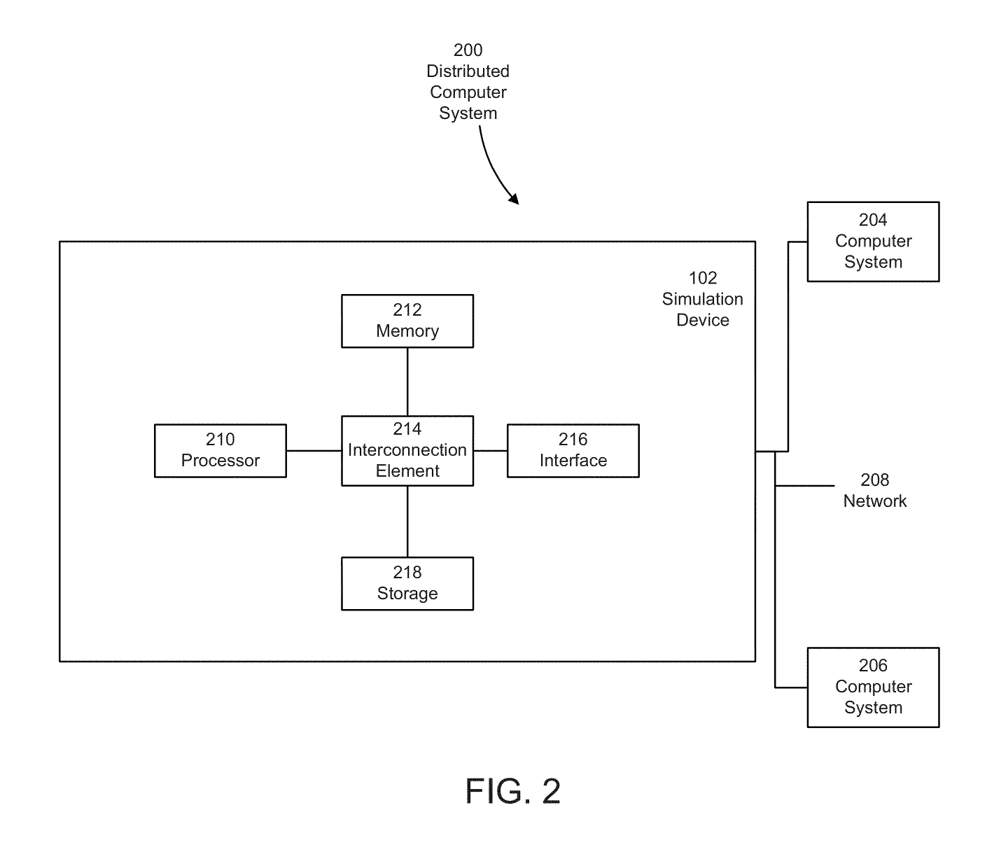

Some embodiments disclosed herein implement a simulation system using one or more computer systems, such as the computer systems described below with reference to FIG. 2. According to these embodiments, a simulation system executes an interactive simulation in which a user manipulates the simulation system and other objects according to a set of simulation rules. These simulation rules may define one or more goals for the simulation and may specify one or more manipulations that may be conducted by a user during the simulation. FIG. 1 illustrates an example simulation system 100. As shown, FIG. 1 includes a simulation device 102, a user 104, and one or more objects 106. The simulation device 102 includes a simulation interface 108, a simulation engine 110, and a data storage device 112. As is described further below, the simulation device 102 may also include a variety of interface components implemented in hardware and software. In at least one embodiment, these interface components may include a touch screen that detects touches through changes in capacitance at one or more locations upon the surface of the touch screen.

According to various embodiments, the objects 106 comprise a wide variety of shapes, colors, densities, substances, and materials. In one embodiment, the objects 106 are primitive shapes, such as a star, triangle, square, circle, diamond, or rectangle. In another embodiment, the objects 106 are characters of an alphabet, such as Latin, Cyrillic, Hebrew, Arabic, Kana, Kanji, and the like. The objects 106 may be classified into various object types based on any of these and other attributes. In some embodiments, each of the objects 106 includes a beveled bottom, which makes the object easier to hold and prevents accidental contact between the hand of the user 104 and the surface of the touch screen. In another embodiment, each of the objects 106 includes an outer layer made of soft plastic to prevent the object from scratching the surface of the touch screen.

In some embodiments, the objects 106 include material, such as conductive silicon and stainless steel, that alters the capacitance of a capacitance-based touch screen when the material comes in contact with the touch screen. It is to be appreciated that, due to the presence of this material, the objects 106 change the capacitance of the touch screen at two or more points of contact between the objects 106 and the surface of the touch screen whether or not the objects 106 are in contact with a human hand. Thus, the objects 106 are detectable by the simulation device 102 with or without (independently of) human contact.

Further, in these embodiments, the material may be disposed in one or more segments on one or more surfaces of the shapes. As described further below, in some embodiments, the attributes of the segments indicate the identity of each shape. Examples of these attributes include the shape and location of each segment, the capacitance altering properties of each segment, and the location of each segment relative to the shape and the other segments. For example, a triangle may have three segments that together form a triangle.

In some embodiments, the objects 106 include two or more contact points that extend away from the body of the objects 106 and rest upon the touch screen when the object is disposed on the simulation device 102. A contact point included within or upon an object may be fabricated using a variety of substances. For example, in some embodiments, the contact points include a material used to create a change in capacitance (e.g. conductive silicon). This material may be disposed upon metal, such as stainless steel, to form the contact point. It is to be appreciated, however, that other substances may be used to fashion contact points, and the embodiments disclosed herein are not limited to a particular substance or combination of substances.

According to a variety of embodiments, the contact points included within an object vary in number, size, shape, and relative position. For example, in one embodiment, each of the objects includes two or three circular contact points. The presence of two or three contact points within an object is advantageous to at least some embodiments. Fewer than two or three contact points may cause some examples of the simulation device 102 to incorrectly identify an object as being present on the touch screen when the surface is touched by a different object, such as a finger or the fingers of the user 104. More than three contact points may cause some examples of the simulation device 102 to incorrectly interpret the presence of an object as a request to perform some other action. For instance, in at least one example, the simulation device 102 may interpret four or more contact points as a “swipe” operation that causes the simulation device 102 to navigate to another screen. It is to be appreciated, however, that the embodiments disclosed herein are not limited to a particular number of contact points. Thus any number of contact points may be included within an object without departing from the scope of the embodiments disclosed herein.

In some embodiments, each circular contact point has a diameter of sufficient size to enable the simulation device 102 to detect the location of the contact point when the object is placed on the touch screen. For some types of touch screens and simulation devices, this diameter is at least, approximately six millimeters. It is to be appreciated, however, that contact points having other dimensions and positions may be used, and the embodiments disclosed herein are not limited to a particular number, size, shape, or relative position of contact points. In addition, it is to be appreciated that objects may provide projections designed to make contact with the touch screen but not to be detectable by the touch screen. For instance, in one example illustrated by FIG. 21, which is described further below, projections 1906 and 1910 are fabricated from a material that does not alter the capacitance of the touch screen.

In some embodiments, the objects 106 are configured to allow users, such as the user 104, to simultaneously see both the objects 106 and the touch screen included in the simulation device 102. According to one embodiment, the objects 106 include an aperture through which a touch screen beneath the objects 106 may be seen. For example, an object may simply be hollow (i.e., be an outline of, for example, a circle rather than a solid disc or dome). In another embodiment, at least a portion of one or more objects is constructed of a transparent or translucent substance, thus enabling users to see through at least a portion of the objects to a touch screen positioned underneath the object.

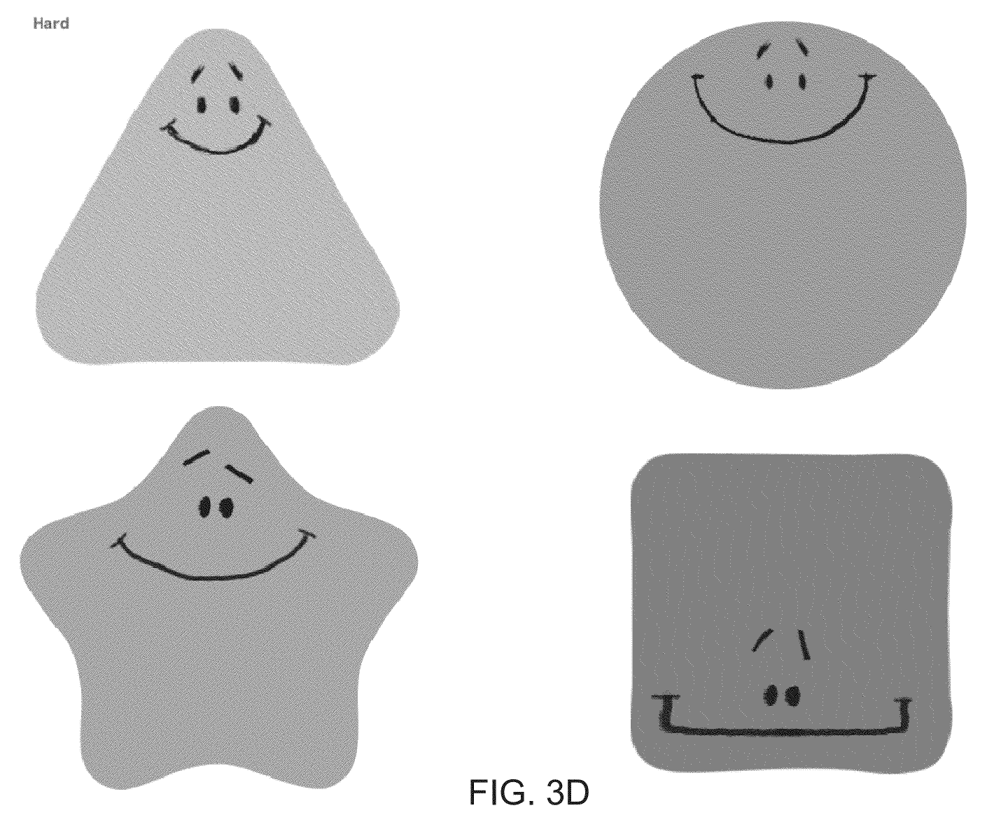

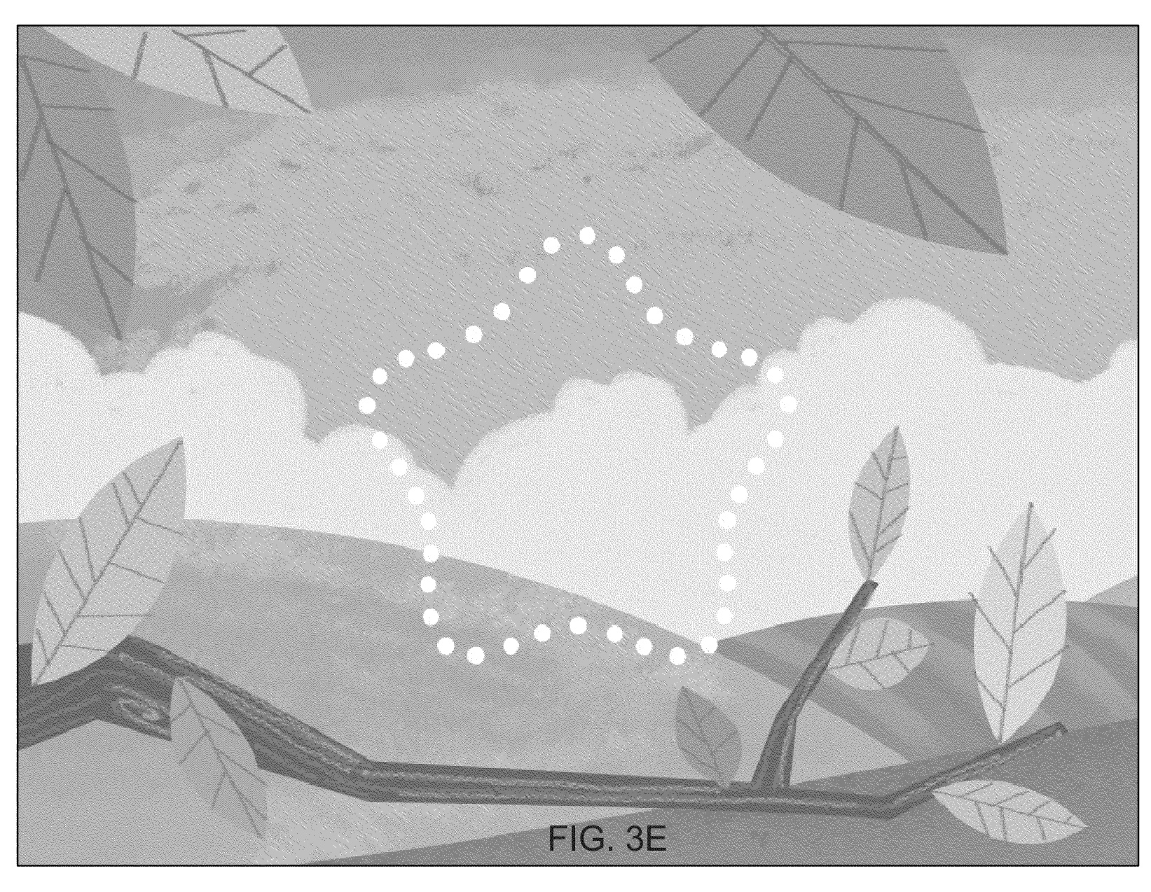

FIGS. 4-6 illustrate one example of a triangular object 400 that includes an aperture 402 and contact points 404, 406, and 408. As shown in FIG. 4, this example of the triangular object is shaded a color, such as green. Further, in this example, the contact points 404, 406, and 408 are arranged according to the dimensions shown in FIG. 6. The dimensions shown in FIG. 6 are expressed in millimeters.

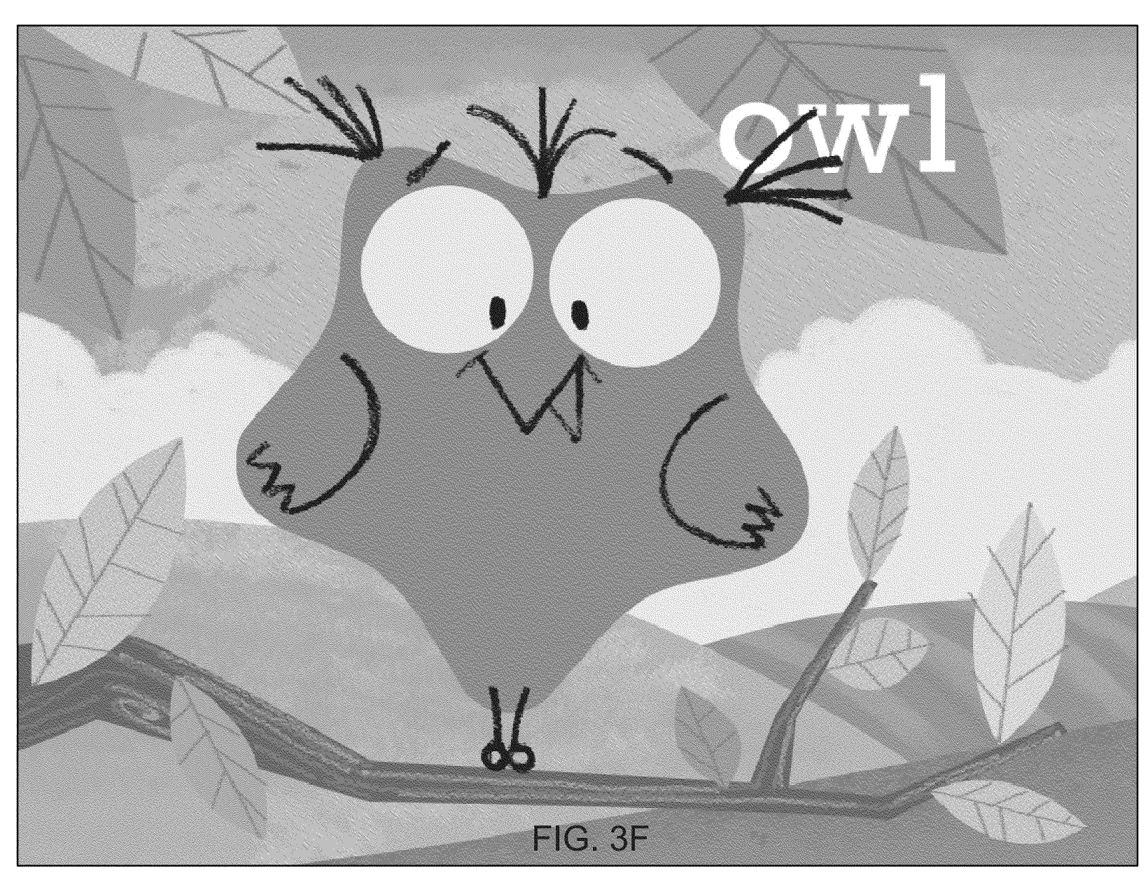

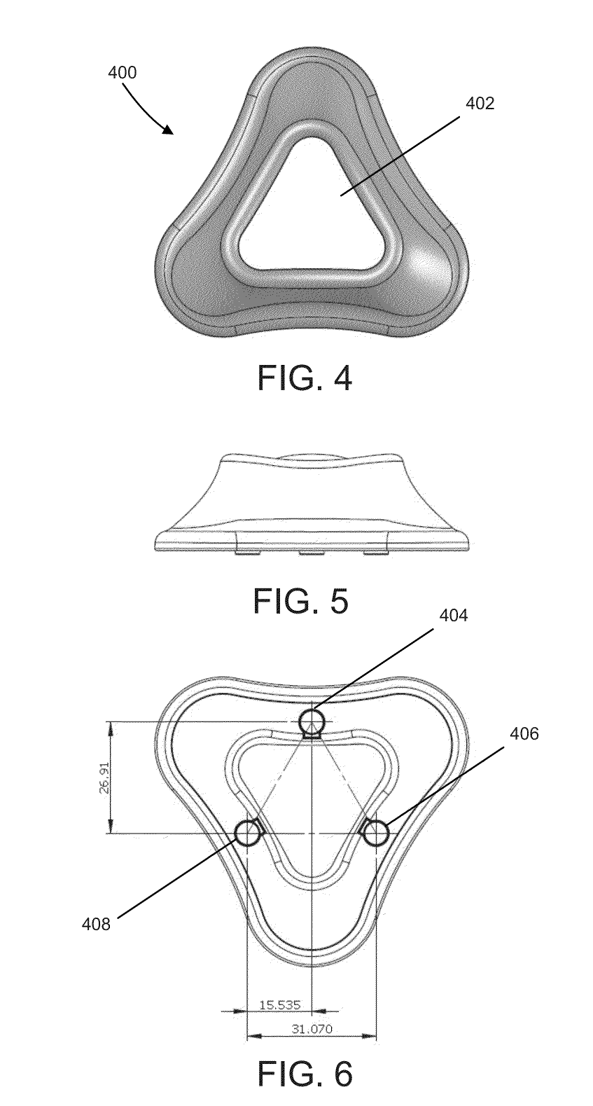

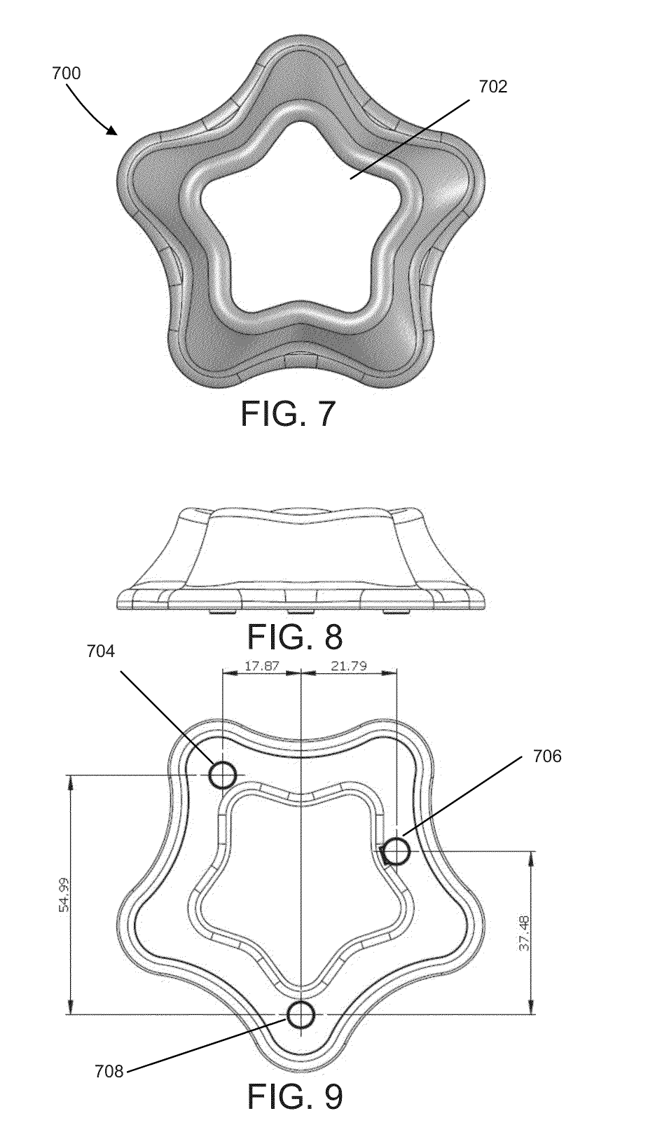

FIGS. 7-9 illustrate one example of a star-shaped object 700 that includes an aperture 702 and contact points 704, 706, and 708. As shown in FIG. 7, this example of the star-shaped object is shaded a color, such as blue. Further, in this example, the contact points 704, 706, and 708 are arranged according to the dimensions shown in FIG. 9. The dimensions shown in FIG. 9 are expressed in millimeters.

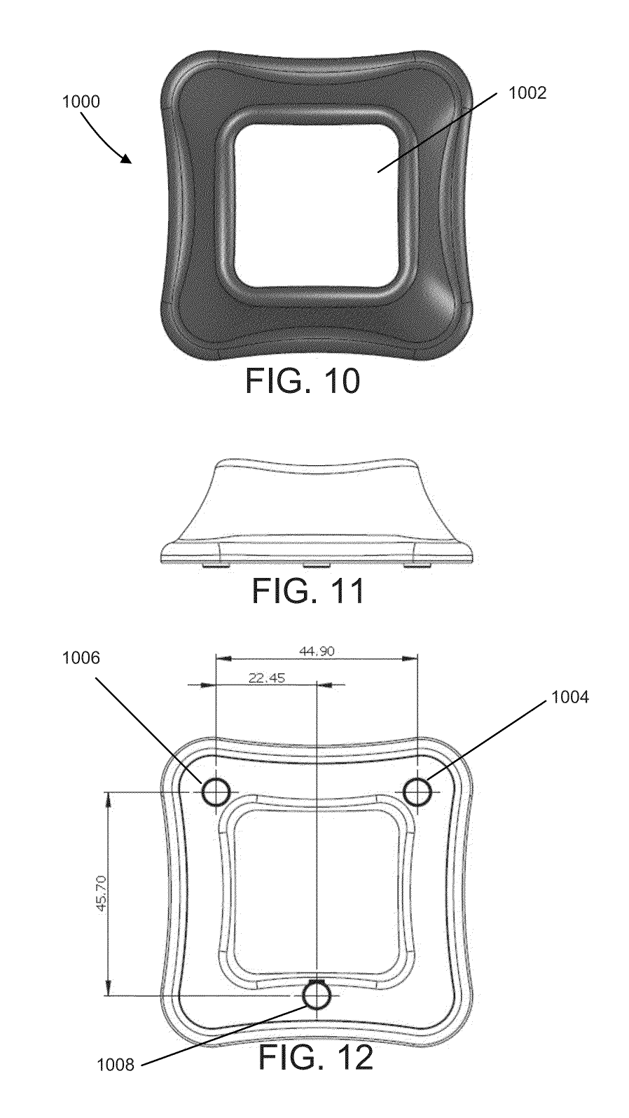

FIGS. 10-12 illustrate one example of a square-shaped object 1000 that includes an aperture 1002 and contact points 1004, 1006, and 1008. As shown in FIG. 10, this example of the square-shaped object is shaded a color, such as red. Further, in this example, the contact points 1004, 1006, and 1008 are arranged according to the dimensions shown in FIG. 12. The dimensions shown in FIG. 12 are expressed in millimeters.

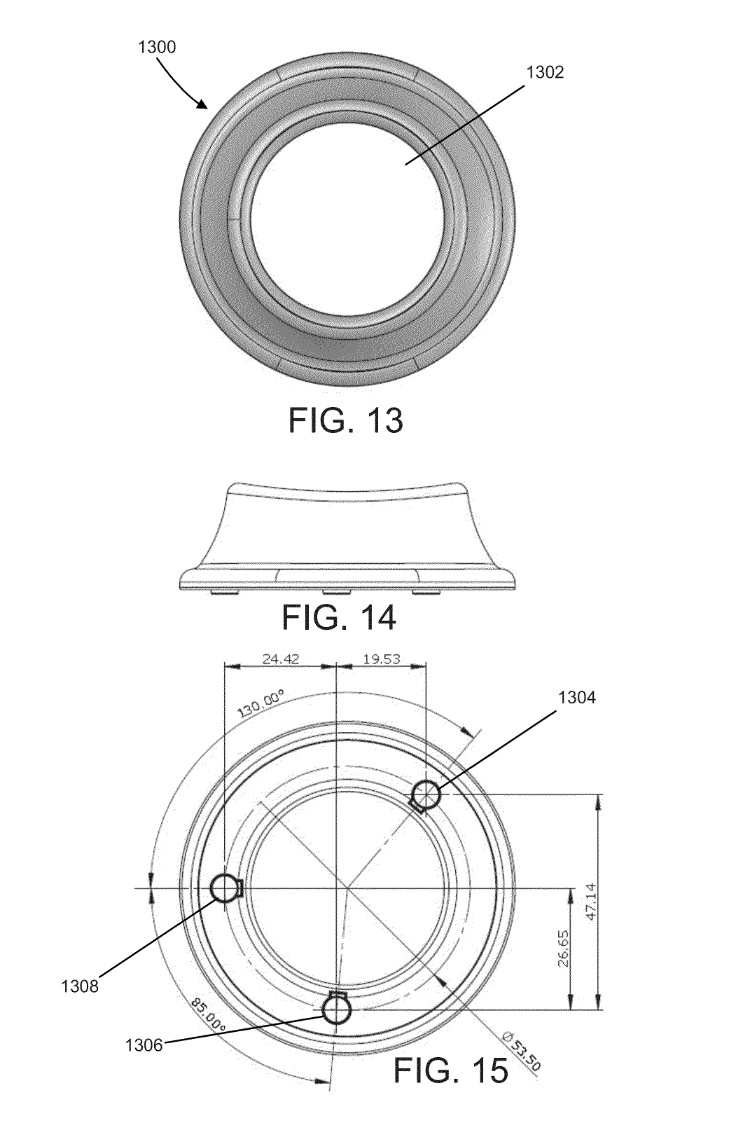

FIGS. 13-15 illustrate one example of a circular object 1300 that includes an aperture 1302 and contact points 1304, 1306, and 1308. As shown in FIG. 13, this example of the circular object is shaded a color, such as yellow. Further, in this example, the contact points 1304, 1306, and 1308 are arranged according to the dimensions shown in FIG. 15. The dimensions shown in FIG. 15 are expressed in millimeters.

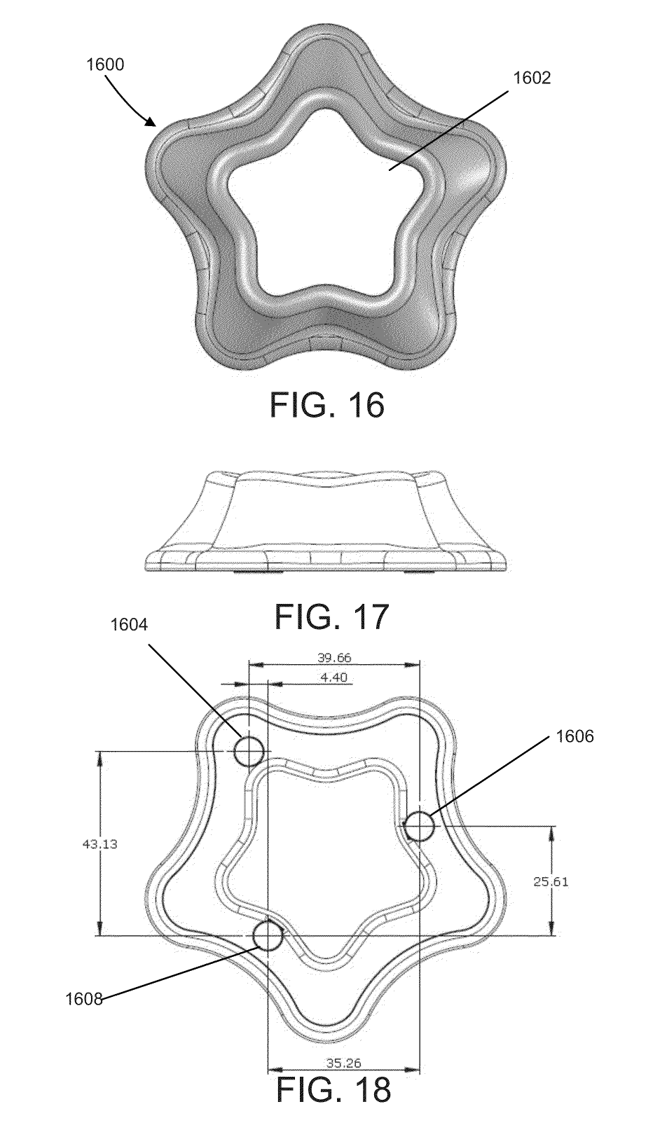

FIGS. 16-18 illustrate another example of a star-shaped object 1600 that includes an aperture 1602 and contact points 1604, 1606, and 1608. As shown in FIG. 16, this example of the star-shaped object is shaded a color, such as blue. Further, in this example, the contact points 1604, 1606, and 1608 are arranged according to the dimensions shown in FIG. 18. The dimensions shown in FIG. 18 are expressed in millimeters.

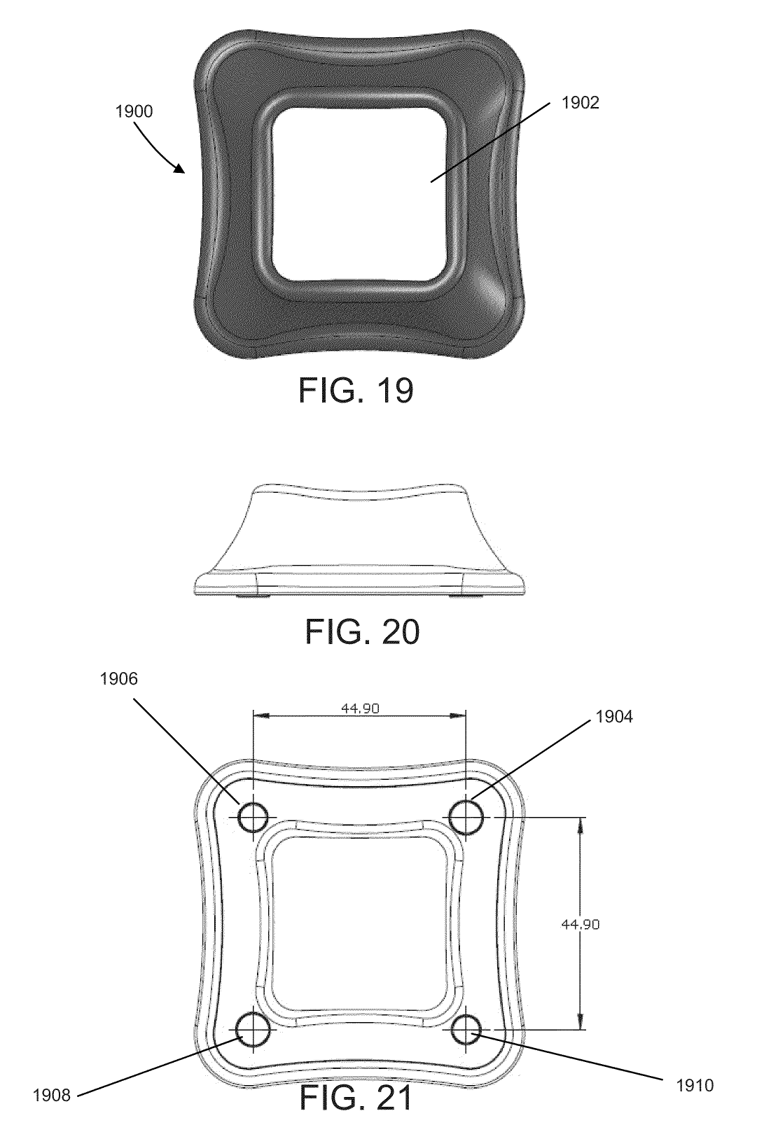

FIGS. 19-21 illustrate one example of a square-shaped object 1900 that includes an aperture 1902, projections 1906 and 1910, and contact points 1904 and 1908. As shown in FIG. 19, this example of the square-shaped object is shaded a color, such as red. Further, in this example, the contact points 1904 and 1908 and the projections 1906 and 1910 are arranged according to the dimensions shown in FIG. 21. The dimensions shown in FIG. 21 are expressed in millimeters.

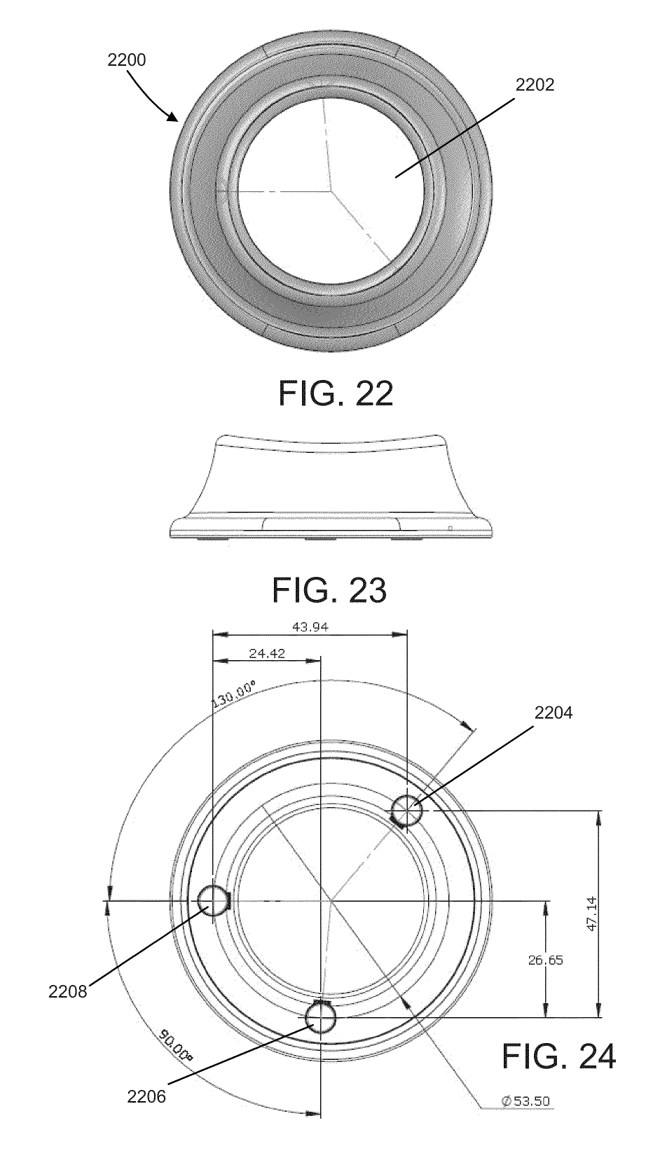

FIGS. 22-24 illustrate one example of a circular object 2200 that includes an aperture 2202 and contact points 2204, 2206, and 2208. As shown in FIG. 22, this example of the circular object is shaded a color, such as yellow. Further, in this example, the contact points 2204, 2206, and 2208 are arranged according to the dimensions shown in FIG. 24. The dimensions shown in FIG. 24 are expressed in millimeters.

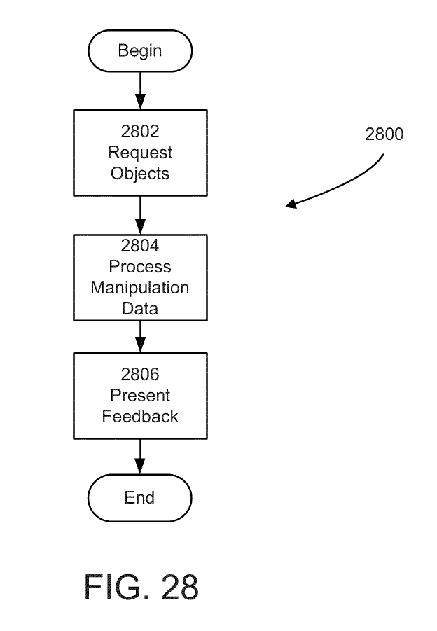

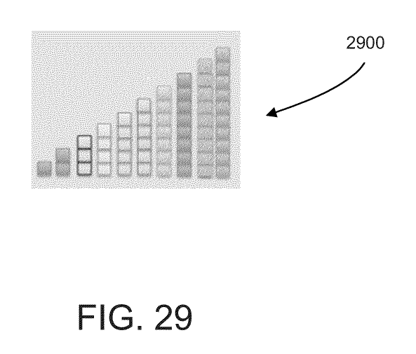

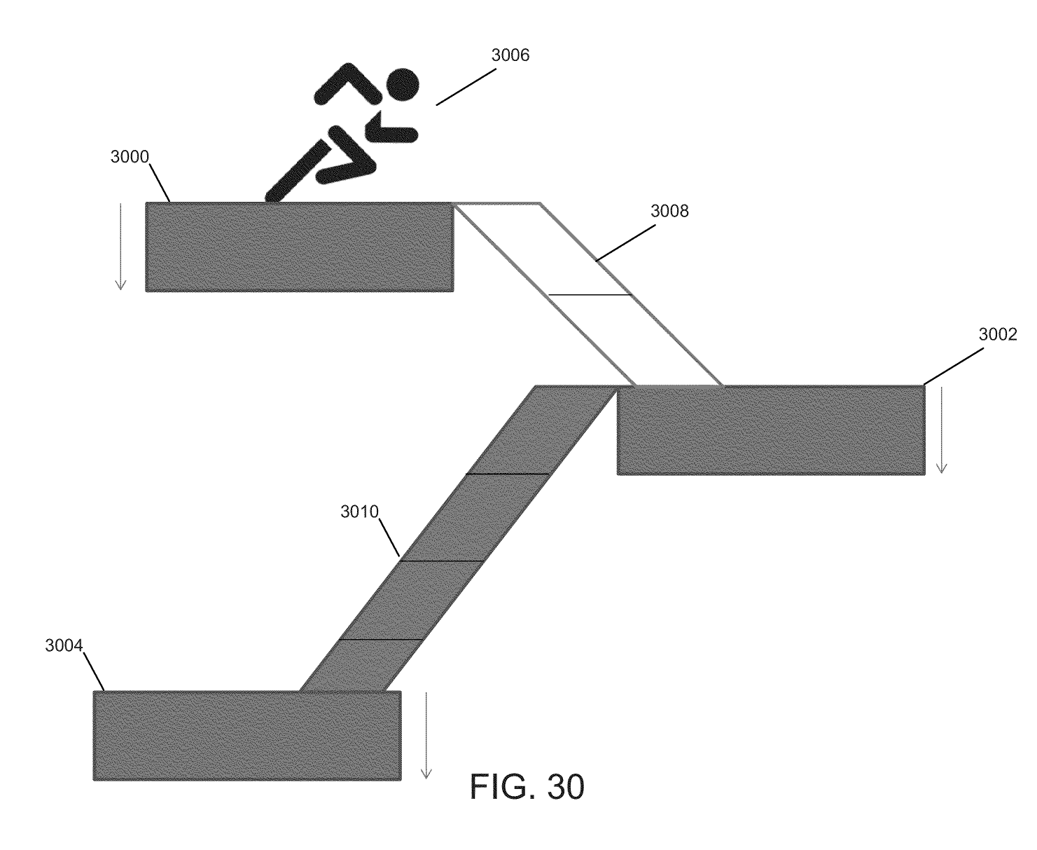

FIG. 29 illustrates one example of a set of rod objects 2900. As shown in FIG. 29, this example includes rods of varying length that are segmented into units. The rods may be shaded a variety of colors. The rods include one or more contact points detectable by the simulation device. In some embodiments, the variety of rods and their segmentation are leveraged to execute a counting simulation, which is described further below with reference to FIGS. 28 and 30.

The simulation interface 108 is configured to receive information descriptive of manipulations of the simulation device 102, or manipulations of the objects 106, performed by the user 104. These manipulations may include screen touches performed by the user 104 and placement (or movement) of the objects 106 upon (or relative to) the simulation device 102. The information descriptive of the manipulations may include information descriptive of the physical attributes of the manipulations or of the objects 106 manipulated. Thus, this information may include indications of the location of a touch (i.e., a point of contact between the user 104 and the simulation device 102), or the location (or locations) of the points of contact between the objects 106 and the simulation device 102. In some embodiments, this information may also include an amount that capacitance changed at each point of contact. In other embodiments, the information may include information gathered from other interface components included in the simulation device 102, such as weight sensors or accelerometers.

Responsive to receiving the information descriptive of the manipulations, the simulation interface 108 provides data reflecting this information to the simulation engine 110. The simulation engine 110 analyzes this data to identify the manipulation or manipulations indicated therein and any objects involved in the manipulations. During this identification process, the simulation engine 110 refers to data stored in the data storage 112.

In some embodiments, the simulation engine 110 is configured to compute the identity, location, and orientation of any of the objects 106 placed on the touch screen of the simulation device 102. For instance, according to one embodiment, the simulation engine 110 attempts to match a two-dimensional pattern created by the points of contact recorded in the manipulation information to a predefined pattern associated with one of the objects 106. These patterns may form a variety of recognizable figures including, for example, numerals, letters, geometric shapes, rods, and combinations thereof. FIGS. 6, 9, 12, 15, 18, 21, 24, and 29 illustrate some examples of the objects and patterns identified by the simulation engine 110, although the scope of the embodiments disclosed herein is not limited to the objects and patterns shown in FIGS. 6, 9, 12, 15, 18, 21, 24, and 29.

In attempting to match the two-dimensional pattern to the predefined pattern, the simulation engine 110 may compute the distances between the points of contact and compare the computed distances to a figure, such as a triangle, rectangle, or square, described within the predefined pattern. For example, in an embodiment where the predefined pattern for the triangular object matches the predefined pattern illustrated in FIG. 6, the simulation engine 110 would compare the computed distances to a predefined pattern of an equilateral triangle having sides that are substantically 31.07 millimeters in length. As referred to herein regarding measurements of length, the term “substantially” accounts for an amount of variance tolerated by the matching computations performed by the simulation engine. This amount of variance may be based on a variety of factors including, among others, the precision of the touch screen, the size of the contact points of the object, and the type of manipulations specified in the simulation rules. In some embodiments, the amount of variance tolerated is a configurable parameter. In one embodiment, this parameter is set to six millimeters to compensate for the diameter of a detectable contact point. As is demonstrated by FIGS. 9, 12, 15, 18, 21, 24, and 29, a figure represented within a predefined pattern may have any of a wide variety of characteristics, and the embodiments disclosed herein are not limited to predefined patterns of figures having a particular size or shape.

In these embodiments, if a match (or an approximate match) is found, the simulation engine 110 stores the identity of the matched and identified object for subsequent processing. In some embodiments, the simulation engine 110 finds an approximate match where the two-dimensional pattern matches the predefined pattern to within a threshold amount of error. In at least one embodiment, the threshold amount of error is a configurable parameter.

In other embodiments, the simulation engine 110 also identifies the location and orientation of the identified object based on the physical dimensions associated with the identified object and the locations of the point of contact between the identified object and the touch screen. Moreover, as demonstrated by FIG. 9, objects may include points of contact that are arranged as vertices of an asymmetrical triangle. In some embodiments, the simulation engine 110 uses the asymmetry of the triangle to further identify the orientation of a particular object.

After identifying the manipulations performed by the user 104, the simulation engine 110 determines the degree to which the manipulations subscribe to the rules of the simulation. Next, the simulation engine 110 generates information descriptive of feedback to be provided to the user 104 in a response to the manipulations. This feedback information may include instructions to produce sensory output that indicates acknowledgement of the manipulation, the degree to which the manipulation complies with the rules of the simulation, and suggestions or cues to increase compliance. For example, if a triangle shape is placed on the simulation device 102 at an incorrect location or incorrect orientation, the feedback information may include instructions to display a visual representation of the triangle on the touch screen underneath the shape. The feedback information may further include instructions to sound a cue as to how to better align the shape on the touch screen (e.g., “move the triangle up”). In another example, if the triangle shape is placed at the correct location and orientation, the feedback information may include instructions to display fireworks and issue a trumpet-like sound and issue a vibration confirming correct placement of the triangle shape. After generating the feedback information, the simulation engine 110 provides the feedback information to the simulation interface 108. Responsive to receiving feedback information, the simulation interface 108 executes any actions instructed by the feedback information.

In some embodiments, the simulation engine 110 tracks the performance of the user 104 and adjusts the difficulty of the simulation based on the past performance of the user 104. For example, according to one embodiment, where a metric summarizing the accuracy of the manipulations conducted by the user 104 exceeds a threshold value, the simulation engine 110 may increase the difficulty of complying with the rules and goals of the simulation. Alternatively, where the metrics falls below another threshold value, the simulation engine 110 may decrease the difficulty of complying with the rules and goals of the simulation. The compliance difficulty of the simulation may be adjusted (increased or decreased) by adjusting (increasing or decreasing) a variety of simulation parameters. For instance, these simulation parameters may include predetermined time periods in which one or more manipulations are to be completed, accuracies required for individual or group manipulations (e.g., how closely manipulations performed by the user must be to predefined manipulations to be recorded as successful), manipulation complexity, and the like.

In other embodiments, the simulation interface 108 provides a configuration interface through which the simulation device 102 receives configuration information specifying rules, goals, and media used during execution of a simulation. For instance, according to one embodiment, the simulation interface 108 includes a set of configuration screens that receive information descriptive of media (e.g., photographs or video) to be used in a simulation (such as for the background of a puzzle) from the user 104. These configuration screens may further enable the user 104 to provide information designating locations upon the media for placement of objects according to the rules and goals of the simulation and to record cues used during the simulation. In these embodiments, responsive to receipt of this configuration information, the simulation interface 108 stores the information in the data storage 112.

In some embodiments, the data storage 112 is configured to store information utilized by the simulation interface 108 and the simulation engine 110. This information may include data descriptive of predefined patterns associated with object types or other attributes of objects, simulation rules, simulation parameters, historical performance of one or more users, and customized configuration, and the like. Data descriptive of the simulation rules may include, for example, data descriptive of predefined manipulations to be conducted by the user, actions to take in response to user performance surpassing predetermined thresholds, actions to take in response to user performance not meeting predetermined criteria, and the like. Data descriptive of the simulation parameters may include, for instance, data descriptive of amounts of error tolerated during object identification, amounts of error tolerated when computing manipulation success, predetermined thresholds of user performance associated with simulation rules and goals (e.g., thresholds used to determine whether simulation difficulty should be adjusted), and feedback information. In at least one embodiment, the data storage 112 is also configured to program instructions executable by at least one processor to implement the simulation interface 108 and the simulation engine 110.

Information may flow between the components illustrated in FIG. 1, or any of the elements, components and subsystems disclosed herein, using a variety of techniques. Such techniques include, for example, passing the information over a network using standard protocols, such as TCP/IP or HTTP, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Embodiments disclosed herein are not limited to the particular configuration illustrated in FIG. 1. Various embodiments may implement the components described above using a variety of hardware components, software components and combinations of hardware and software components. In addition, various embodiments may utilize additional components configured to perform the processes and functions described herein.

### Simulation Device

Some examples disclosed herein provide for a simulation device that executes one or more interactive simulations. In at least some examples, the simulation device is implemented as specialized hardware and software components executing within a computer system. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones, personal digital assistants, and tablet computing devices, and network equipment, such as load balancers, routers and switches.

FIG. 2 is a schematic diagram of a distributed computing system 200 that includes an example of a simulation device 102. As shown, the simulation device 102 is coupled to computer systems 204 and 206 via the network 208. The network 208 may include any communication network through which computer systems may exchange (e.g. send or receive) information. For example, the network 208 may be a public network, such as the internet, and may include other public or private networks such as LANs, WANs, extranets and intranets. As shown, the simulation device 102 exchanges data with the computer systems 204 and 206 via the network 208. While the distributed computer system 200 illustrates three networked computer systems, the distributed computer system 200 is not so limited and may include any number of computer systems and computing devices, networked using any medium and communication protocol.

As illustrated in FIG. 2, the simulation device 102 includes several components common to computer systems. These components include a processor 210, a memory 212, an interconnection element 214, an interface 216 and data storage 218. To implement at least some of the processes disclosed herein, the processor 210 performs a series of instructions that result in manipulated data. The processor 210 may include any type of processor, multiprocessor or controller. For instance, the processor 210 may include a commercially available processor such as an Intel Xeon, Itanium, Core, Celeron, Pentium, AMD Opteron, Sun UltraSPARC or IBM Power5+. In the illustrated example, the processor 210 is coupled to other system components, including memory 212, interfaces components 216 and data storage 218, by the interconnection element 214.

In some examples, the memory 212 stores programs and data during operation of the simulation device 102. According to these examples, the memory 212 includes a relatively high performance, volatile, random access memory such as a dynamic random access memory (DRAM) or static memory (SRAM). However, the memory 212 is not limited to these particular memory devices and may include any device for storing data, such as a disk drive or other nonvolatile, non-transitory storage device. In addition, various examples organize the memory 212 into particularized and, in some cases, unique structures to perform the functions disclosed herein. In these examples, the data structures are sized and arranged to store values for particular types of data.

As shown, the components of the simulation device 102 are coupled by the interconnection element 214. In some examples, the interconnection element 214 includes one or more interconnection elements such as physical busses between components that are integrated within the same machine. However, the interconnection element 214 may include any communication coupling between system elements including specialized or standard computing bus technologies such as IDE, SCSI, PCI and InfiniBand. Thus, the interconnection element 214 enables communications, such as data and instructions, to be exchanged between the components of the simulation device 102.

As illustrated, the simulation device 102 also includes one or more interface components 216 that receive input or provide output. According to various examples, the interface components 216 include input devices, output devices and combination input/output devices. Output devices render information for external presentation. Input devices accept information from external sources. Some example input and output devices include keyboards, mouse devices, trackballs, microphones, touch screens, printing devices, scanning devices, digital cameras, display screens, speakers, vibration generating devices, network interface cards and the like. The interface components 216 allow the simulation device 102 to exchange (i.e. provide or receive) information and communicate with external entities, such as users and other systems.

According to some examples, the simulation device 102 exchanges data using one or more interface components 216 via the network 208 by employing various methods, protocols and standards. These methods, protocols and standards include, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the simulation device 102 may transmit data via the network 208 using a variety of security measures including, for example, TSL, SSL or VPN.

Further, in the example shown, the data storage 218 includes a computer readable and writeable nonvolatile, non-transitory data storage medium. Particular examples of this non-transitory data storage medium include optical disk, magnetic disk, flash memory and the like. During operation of some examples, a processor, such as the processor 210 or some other controller, causes data to be read from the storage medium into another memory, such as the memory 212, that allows for faster access to the information by the processor 210 than does the storage medium included in the data storage 218. Further, according to these examples, the processor 210 manipulates the data within the faster memory, and then directly or indirectly causes the data to be copied to the storage medium associated with the data storage 218 after processing is completed. The faster memory discussed above may be located in the data storage 218, in the memory 212 or elsewhere. Moreover, a variety of components may manage data movement between the storage medium and other memory elements and examples are not limited to particular data management components. Further, examples are not limited to a particular memory system or data storage system.

Information may be stored on the data storage 218 in any logical construction capable of storing information on a computer readable medium including, among other structures, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

In some examples, the data storage 218 stores instructions that define a program or other executable object. In these examples, when the instructions are executed by the processor 210, the processor 210 performs one or more of the processes disclosed herein. Moreover, in these examples, the data storage 218 also includes information that is recorded, on or in, the medium, and that is processed by the processor 210 during execution of the program or other object. This processed information may be stored in one or more data structures specifically configured to conserve storage space or increase data exchange performance. The instructions may be persistently stored as encoded signals, and the instructions may program the processor 210 to perform any of the functions described herein.

Although the simulation device 102 is shown by way of example as one type of simulation device upon which various aspects, functions and processes may be practiced, aspects, functions, and processes are not limited to being implemented on the simulation device 102 as shown in FIG. 2. Various aspects, functions and processes may be practiced on one or more simulation device having a different architectures or components than that shown in FIG. 2. More specifically, examples of the simulation device 102 include a variety of hardware and software components configured to perform the functions described herein and examples are not limited to a particular hardware component, software component or particular combination thereof. For instance, the simulation device 102 may include software components combined with specially programmed, special-purpose hardware, such as an application-specific integrated circuit (ASIC) tailored to perform particular operations disclosed herein. While in another example the simulation device 102 may perform these particular operations, or all operations, using a device running a version of iOS, such as an IPAD, IPHONE, or IPOD TOUCH, or a device running a version of Android, such as a KINDLE FIRE available from Amazon.com, Inc of Seattle, Wash.

The simulation device 102 may be a computer system including an operating system that manages at least a portion of the hardware elements included in the simulation device 102. In some examples, a processor or controller, such as the processor 210, executes an operating system. Examples of a particular operating system that may be executed include a Windows-based operating system, such as, Windows NT, Windows 2000 (Windows ME), Windows XP, Windows Vista, Windows 7, Windows 8 operating systems, available from the Microsoft Corporation, a MAC OS System X operating system available from Apple, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Moreover, the functional components disclosed herein may include a wide variety of elements, e.g. specialized hardware, executable code, data structures or objects, that are configured to perform the functions described herein. Information may flow between the elements, components and subsystems described herein using a variety of techniques. Such techniques include, for example, passing the information over a network using standard protocols, such as TCP/IP, passing the information between functional components in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the examples disclosed herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Simulation Processes

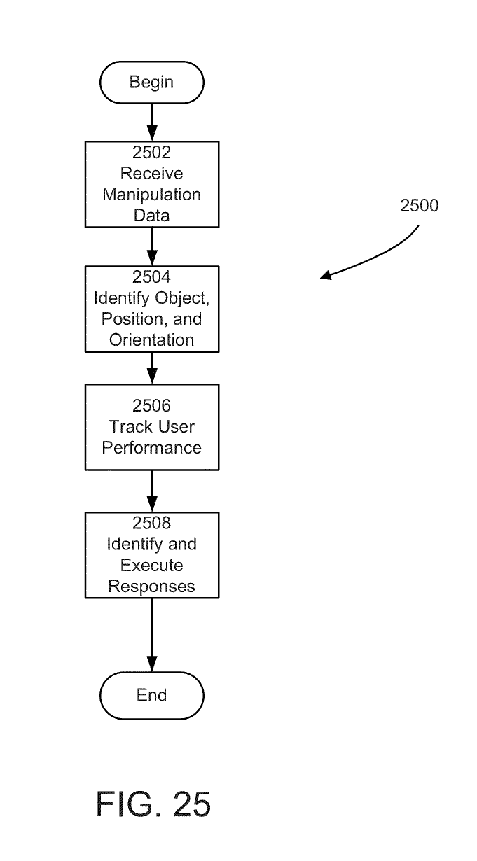

Some embodiments described herein perform simulation processes within a simulation system, such as the simulation system 100 described above with reference to FIG. 1. One example of such a simulation process is illustrated in FIG. 25. According to this example, the simulation process 2500 includes several acts receiving manipulation information, identifying one or more objects, the location of the one or more objects, and the orientation of the one or more objects, computing a user performance metric, providing feedback, and adjusting parameters of the simulation.

In act 2502, manipulation information is received. In one embodiment, the manipulation information is received by a simulation interface, such as the simulation interface 108 described above with reference to FIG. 1. In this embodiment, the simulation interface provides the manipulation information to a simulation engine, such as the simulation engine 110 described above with reference to FIG. 1.

In act 2504, the simulation engine processes the manipulation information to identify the object subject to manipulation, the location of the object as recorded in the manipulation information, and the orientation of the object as recorded in the manipulation information. Where the manipulation recorded within the manipulation information includes a movement of the object, the simulation engine may identify multiple locations and orientations. These locations and orientation may include a starting location and orientation, an ending location and orientation and one or more intermediate locations and orientations therebetween.

In act 2506, the simulation engine determines performance of a user, such as the user 104 described above with reference to FIG. 1, in conducting the simulation. In some embodiments, the simulation engine makes this determination by determining a degree to which the manipulation recorded in the manipulation information complies with the rules of the simulation. In at least one embodiment, the simulation engine computes this determination by calculating a metric that indicates a level of compliance achieved.

In act 2508, the simulation engine identifies one or more actions to execute in response to the user's performance. For example, where the simulation engine determines that the user's performance achieves a goal of the simulation, the simulation engine may identify complimentary or rewarding feedback information that is then presented to the user via the simulation interface. In addition, in some embodiments, when the user's performance surpasses a predefined threshold, the simulation engine may increase the difficulty of the simulation via one or more simulation parameters. In another example, where the simulation engine determines that the user's performance does not meet predetermined criteria (e.g., the performance is low due to inaccuracy, expiration of a predetermined time period, a goal not being achieved within a target number of attempts, or other evaluation parameters), the simulation engine may identify information to assist the user in increasing performance that is then presented to the user via the simulation interface. In addition, in some embodiments, if the user's performance fails to surpass another predefined threshold in accordance with simulation rules, the simulation engine may decrease the difficulty of the simulation via one or more simulation parameters. The simulation engine terminates the simulation process 2500 after execution of the act 2508. It is to be appreciated that the simulation process 2500 may be repeated to provide a user with one or more simulations.

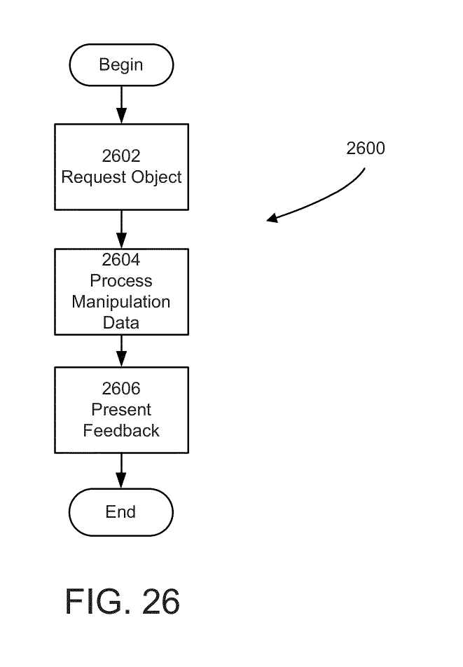

Some embodiments implement additional simulation processes. Examples of these simulation processes include matching simulation processes, stamping simulation processes, and construction simulation processes. FIG. 26 illustrates a matching simulation process 2600. As shown in FIG. 26, the matching simulation process 2600 includes acts of requesting an identified object, processing manipulation data, and presenting feedback to the user.

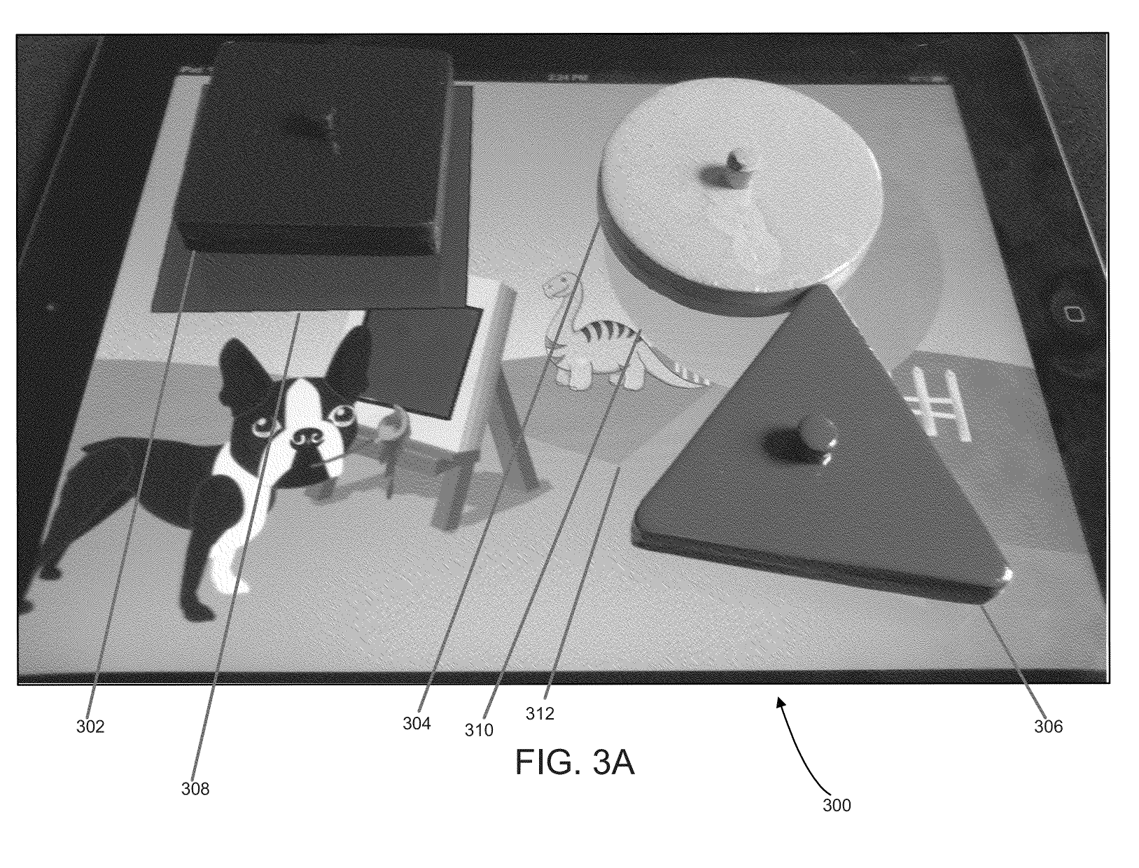

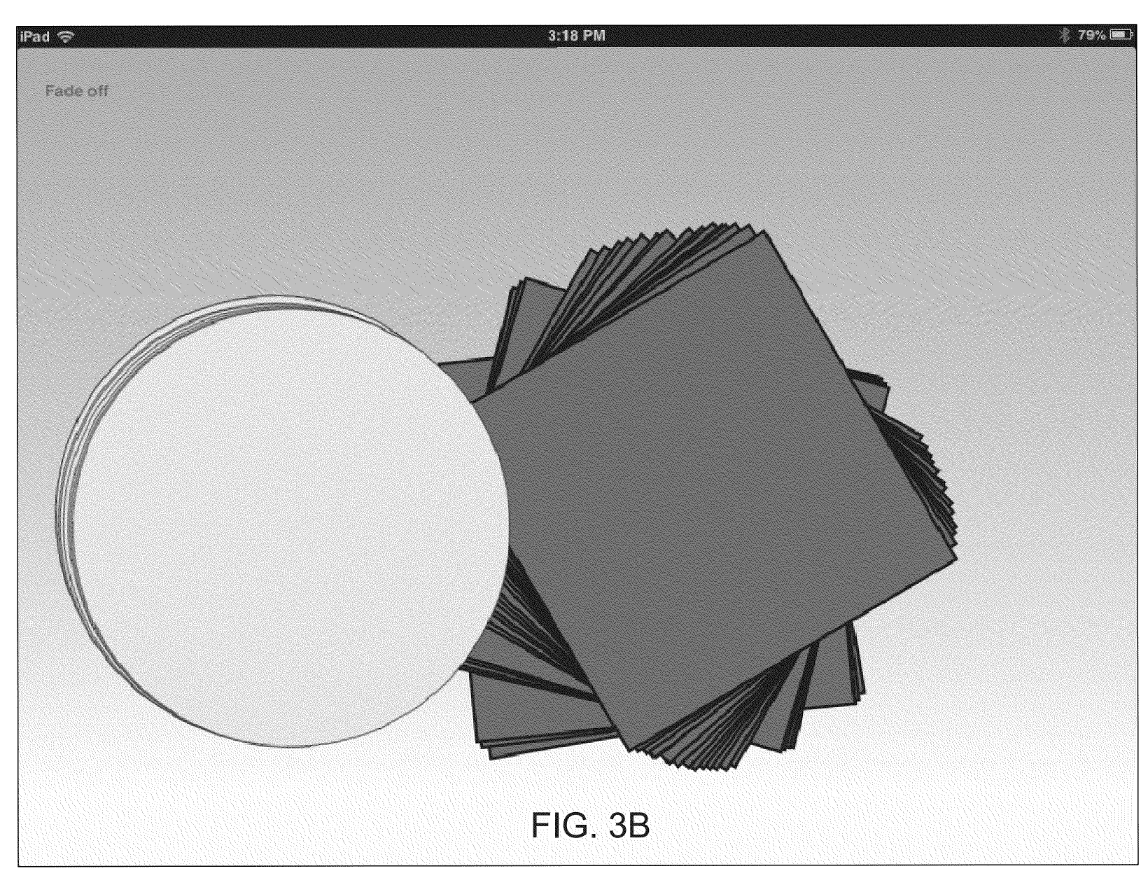

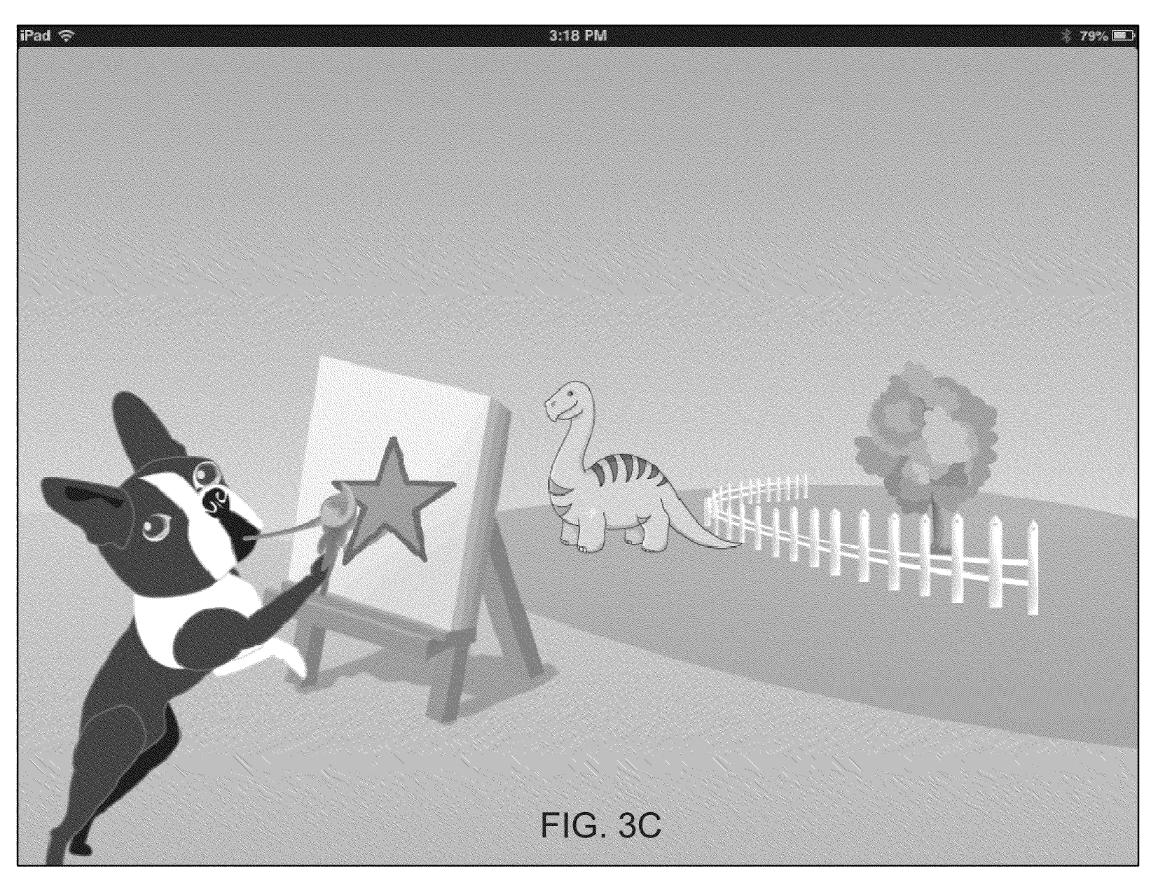

In act 2602, a simulation system, such as the simulation system 100 described above with reference to FIG. 1, prompts a user, via a simulation interface, to place an identified object on the touch screen. The object may be any object detectable by the simulation system 100, such as a geometric figure, numeral, letter, or other figure. The simulation interface may present a prompt using a variety of media, such as graphical images, colors, sounds, motion (e.g., vibration), or a combination thereof. For instance, in one embodiment, when executing the act 2602, the simulation interface presents a screen in accordance with the screen illustrated in FIG. 3C, which is described further below. In another embodiment, when executing the act 2602, the simulation interface presents an unadorned screen shaded a particular color to prompt the user to place an identified object (e.g., any object of the same color) upon the touch screen.

In act 2604, the simulation engine receives manipulation data and determines whether the user placed the identified object on the touch screen within a predetermined time period. In act 2606, the simulation interface presents feedback to the user based on the accuracy and timeliness of the user's placement of the identified object on the touch screen. Where the user placed the identified object on the touch screen within the predetermined time period, the simulation engine may record the manipulation as a match and the simulation interface may present positive feedback information, such as a song, fireworks, congratulations, or other reward. Where the user fails to place the indentified object on the touch screen within the predetermined time period, the simulation interface may record the failure and respond with helpful information, such as visual or audio instructions to assist in selecting the identified object.

The simulation system terminates the matching process 2600 after execution of the act 2606. It is to be appreciated that the matching process 2600 may be repeated to provide a user with one or more simulations. In addition, each step of the matching process 2600 may include more than one identified object to be matched by placing the object on the touch screen.

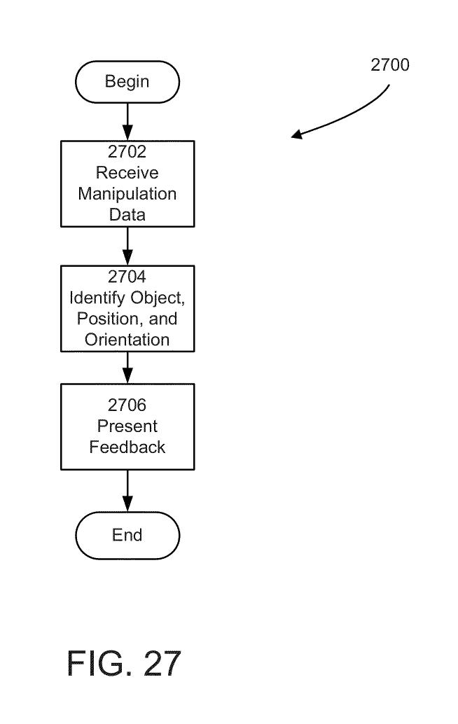

FIG. 27 illustrates a stamping simulation process 2700. As shown in FIG. 27, the stamping simulation process 2700 includes acts of receiving manipulation data, identifying characteristics of an object (such as identity, position, and orientation), and presenting feedback to a user.

In act 2702, a simulation system, such as the simulation system 100 described above with reference to FIG. 1, receives manipulation data via a simulation interface. The manipulation data may include information descriptive of one or more locations on the touch screen upon which an object was placed. The object may be any object detectable by the simulation system 100, such as a geometric figure, numeral, letter, or other figure.

In act 2704, the simulation engine records the identity of the object and the one or more locations. In act 2706, the simulation interface presents feedback to the user based on the one or more locations. For instance, in one embodiment, when executing the act 2706, the simulation interface presents a screen in accordance with the screen illustrated in FIG. 3B, which is described further below.

In another embodiment, when executing the act 2706, the simulation interface presents both visual representations and audio descriptions of the locations and identity of the objects. For instance, where the objects are letters, the simulation interface may pronounce sounds for individual letters, syllables for letters placed within a configurable distance of one another that in combination form a syllable, and words for letters placed within a configurable distance of one another that in combination form a word.

The simulation system terminates the stamping process 2700 after execution of the act 2706. It is to be appreciated that the stamping process 2700 may be repeated to provide a user with one or more simulations.

FIG. 28 illustrates a construction simulation process 2800. As shown in FIG. 28, the construction simulation process 2800 includes acts of requesting one or more objects, processing manipulation data, and presenting feedback to the user.

In act 2802, a simulation system, such as the simulation system 100 described above with reference to FIG. 1, prompts a user, via a simulation interface, to place one or more identified objects at one or more locations on the touch screen. The objects may be any objects detectable by the simulation system 100, such as a geometric figure, numeral, letter, rod, or other figure. The simulation interface may present a prompt using a variety of media, such as graphical images, colors, sounds, motion (e.g., vibration), or a combination thereof. For instance, in one embodiment, when executing the act 2802, the simulation interface presents a screen in accordance with the screen illustrated in FIGS. 3E, 3F, and 30, which are described further below.

In some embodiments, within the act 2802, the simulation interface prompts the user to construct a composite object by combining two or more objects at specified locations on the touch screen. Examples of composite objects include representations of animals, vehicles, structures, words, equations, and the like.

In some embodiments, within the act 2802, the simulation interface presents prompts that are static (e.g., prompts that remain in a single location on the touch screen). In other embodiments, the simulation interface presents prompts that are dynamic (e.g. prompts that change location on the touch screen).

In act 2804, the simulation engine receives manipulation data and determines whether the user placed the identified the one or more objects at one or more correct locations on the touch screen within one or more predetermined time periods. Where the simulation interface prompts the user to construct a composite object, this determination involves identifying each object, the location of each object, the orientation of each object, and the timing associated with the placement of each object. Where the simulation interface presents dynamic prompts, this determination involves identifying an object and the location and the orientation of the object at one or more points in time. In these embodiments, the simulation engine is configured to use the relative locations of the prompt and the object at identified points in time to determine whether the user was able to “catch” the prompt. In some embodiments, the simulation engine records a catch where the object overlays the prompt to within a configurable amount of error at one or more physical and temporal points.

In act 2806, the simulation interface presents feedback to the user based on the accuracy and timeliness of the user's placement of the identified object or objects on the touch screen. Where the user placed the identified object or objects in the correct location or locations within the predetermined time period or time periods, the simulation engine may record the manipulation as a success and present a reward, such as a song, fireworks, congratulations, and the like. Where the user fails to place an identified object in a correct location within a predetermined time period, the simulation interface may record the failure and respond with helpful information, such as visual or audio instructions on moving the object to the correct location.

The simulation system terminates the construction process 2800 after execution of the act 2806. It is to be appreciated that the construction process 2800 may be repeated to provide a user with one or more simulations.

Processes such as the simulation processes 2500-2800 enable simulation devices to interact with external objects in a manner that is both enjoyable and educational to users. It is to be appreciated that the simulation processes 2500-2800 may follow one particular sequence of acts in a particular example. The acts included in this process may be performed by, or using, one or more specially configured simulation devices as discussed herein. Some acts are optional and, as such, may be omitted in accordance with one or more examples. Additionally, the order of acts can be altered, or other acts can be added, without departing from the scope of the systems and methods discussed herein. Furthermore, as discussed above, in at least one example, the acts are performed on a particular, specially configured machine. For instance, such acts may be performed by a simulation device configured according to the examples and embodiments disclosed herein.

### Simulation Interfaces

In some embodiments, a simulation interface, such as the simulation interface 108 described above with reference to FIG. 1, is configured to present user interface elements as illustrated in FIGS. 3A-3F. FIG. 3A illustrates a simulation device 300 with objects 302, 304, and 306 disposed thereon. As illustrated in FIG. 3A the simulation interface has presented respective responses 308, 310, and 312 to the placement of the objects 302, 304, and 306. These responses include displaying two dimensional representations of the objects have the same shape and color as the objects.

FIG. 3B illustrates a screen displayed by the simulation device 300 in response to placements of objects on the surface of the touch screen while the simulation device operates in a stamp simulation. In this example, the simulation interface presents multiple representations of objects in the locations where the objects were in contact with the touch screen. This contact may have been multiple, discrete placements followed by removals or may have been a single placement, followed by a movement, followed by a removal. In some embodiments, older representations may fade over time. In other embodiments, older representations do not fade. In at least one example, this fading function is configurable via a simulation parameter.

FIG. 3C illustrates a screen displayed by the simulation device 300 while executing a matching simulation. As shown, the simulation interface prompts the user to place an object matching the object shown on the easel (e.g., a blue star) on the touch screen.

FIGS. 3D-3F illustrate a screens displayed by the simulation device 300 while executing a shape safari simulation. As shown, the simulation interface displays the screen illustrated in FIG. 3D as an introduction to the shape utilized by this simulation. In this example, the simulation interface next displays the screen illustrated in FIG. 3F to prompt the user to place a star within the dotted outline shown. Where the simulation interface receives manipulation data that the simulation engine identifies as a successful manipulation of the star, the simulation interface presents a response including positive feedback information shown in FIG. 3F. In this example, the simulation engine identifies placement of the star within the dotted outline as a success. In response to the success, the simulation presents a smiling owl.

FIG. 30 illustrates a screen displayed by the simulation device 300 while executing a specific version (e.g., a counting simulation) of the construction simulation described above with reference to FIG. 28. As shown in FIG. 30, the simulation interface displays levels 3000, 3002, and 3004 that may be traversed by a character 3006 in response to a user placing a rod having the indicated number of units at one or more target locations 3008 and 3010 on the screen. Thus, the rules of the counting simulation require that the user recognize (or count) the number of units displayed at a target location, find a rod with the matching number of units, and place the matching rod at the target location. As shown in FIG. 30, the simulation interface displays the character 3006 moving from the level 3000 to the level 3002 responsive to the user placing a rod including two units at the target location 3008. Next, in response to detecting that the user placed a rod including four units at the target location 3010, the simulation interface displays the character 3006 moving from the level 3002 to the level 3004.

In some embodiments, the rod locations traverse horizontal levels. In other embodiments, the rod locations and levels are organized to simulate the character moving in any direction. In some embodiments, the compliance difficulty increases as the simulation progresses. For instance, the period of time specified in the counting simulation rules for the user to place the correct rod in the correct location may decrease as the character progresses through levels.

It is to be appreciated that the levels and characters may vary between embodiments to provide different simulated settings. For instance, in one embodiment, the levels are tree branches that provide for a jungle setting for the simulation. In another embodiment, the levels are ledges that provide for a mountain setting. Other multimedia elements may be included to provide for a variety of story lines and settings.

The interface elements illustrated in FIGS. 3A-3F and 30 are specific to particular embodiments. However, it is to be appreciated that the embodiments disclosed herein are not limited to the particular elements illustrated within FIGS. 3A-3F and 30.

Having thus described several aspects of at least one example, it is to be appreciated that various alterations, modifications, and improvements will readily occur to those skilled in the art. For instance, examples disclosed herein may also be used in other contexts or with other technologies, such as resistive, infrared and surface acoustic wave touch screens. Such alterations, modifications, and improvements are intended to be part of this disclosure, and are intended to be within the scope of the examples discussed herein. Accordingly, the foregoing description and drawings are by way of example only.

What is claimed is:

1. A system configured to execute at least one simulation, the system comprising:
a memory;
a touch screen;
at least one processor coupled to the memory and the touch screen; and
a simulation component executed by the at least one processor and configured to:
detect a manipulation of at least one object disposed on the touch screen;
determine a degree of compliance of the manipulation to rules of the at least one simulation; and
communicate a characterization of the degree of compliance to an external entity.

2. The system according to claim 1, wherein the simulation component is configured to communicate the characterization by displaying a representation of the at least one object on the touch screen.

3. The system according to claim 1, wherein the simulation component is configured to communicate the characterization by communicating suggestions to enable an increase in the degree of compliance.

4. The system according to claim 1, wherein the simulation component is further configured to:
determine that the degree of compliance transgresses a threshold; and
adjust difficulty of the at least one simulation in response to the degree of compliance transgressing the threshold.

5. The system according to claim 1, wherein the simulation component is configured to determine the degree of compliance at least in part by identifying the at least one object.

6. The system according to claim 5, wherein the simulation component is configured to identify the at least one object at least in part by comparing a plurality of locations on the touch screen to a plurality of predefined patterns, the plurality of locations on the touch screen being in contact with a plurality of contact points of the at least one object.

7. The system according to claim 6, wherein each predefined pattern of the plurality of predefined patterns is associated with at least one of a triangle, a star, a square, and a circle.

8. The system according to claim 7, further comprising a plurality of objects including the at least one object, each of the plurality of objects comprising a material that the system can detect while the object is not in contact with a user.

9. The system according to claim 8, wherein the material includes at least one of conductive silicon and stainless steel.

10. The system according to claim 9, wherein each of the plurality of objects is configured to allow light to pass through at least one of a portion of the object and an aperture formed by the object.

11. The system according to claim 10, wherein each of the plurality of objects includes a beveled bottom.

12. An object for use with at least one simulation system, the object comprising a plurality of contact points fabricated from a material that the simulation system can detect while the object is not in contact with a user.

13. The object according to claim 12, wherein the material includes at least one of conductive silicon and stainless steel.

14. The object according to claim 13, wherein the object is configured to allow light to pass through at least one of a portion of the object and an aperture formed by the object.

15. The object according to claim 14, wherein the object includes a beveled bottom.

16. A method of conducting a simulation using a computer system including a memory, a touch screen, and at least one processor coupled a memory and the touch screen, the method comprising:
detecting a manipulation of at least one object disposed on the touch screen;
determining a degree of compliance of the manipulation to rules of the at least one simulation; and
communicating a characterization of the degree of compliance to an external entity.

17. The method according to claim 16, further comprising:
determining that the degree of compliance transgresses a threshold; and
adjusting difficulty of the at least one simulation in response to the degree of compliance transgressing the threshold.

18. The method according to claim 16, wherein determining the degree of compliance includes identifying the at least one object.

19. The method according to claim 18, wherein identifying the at least one object includes comparing a plurality of locations on the touch screen to a plurality of predefined patterns, the plurality of locations on the touch screen being in contact with a plurality of contact points of the at least one object.

20. The method according to claim 19, wherein comparing the plurality of locations on the touch screen to the plurality of predefined patterns includes comparing the plurality of locations with a plurality of predefined patterns including at least one predefined pattern associated with at least one of a triangle, a star, a square, and a circle.
